(19) United States
(12) Patent Application Publication
(10) Pub. No.: US 2008/0203837 A1
(43) Pub. Date: Aug. 28, 2008

(54) Ceiling fan D. C. motor

(75) Inventor: Patrick Tang, Taichung City (TW)

Correspondence Address: BRUCE H. TROXELL, SUITE 1404, 5205 LEESBURG PIKE, FALLS CHURCH, VA, 22041, US

(73) Assignees: Yong Shin T. Electric Machine Co., Ltd.; Shieq Shuenn Enterprise Co., Ltd.

(21) Appl. No.: 11/711,888

(22) Filed: Feb. 28, 2007

(51) Int. Cl. H02K 1/28; H02K 1/27; H02K 5/04; H02K 5/22

(52) U.S. Cl. 310/89; 310/156.38

(57) ABSTRACT

A ceiling fan D.C. motor includes a stator and a rotor fitted around the outer circumference of the stator. The rotor is composed of a holder, annular base, a plurality of permanent magnets and a cover. The holder has its circumferential edge provided with an annular wall formed inside with an accommodating space, and its upper side formed with an opening. The annular base is secured inside the circumferential wall of the holder and has its circumferential edge disposed with a plurality of engage studs spaced apart, extending longitudinally toward the opening of the holder and respectively formed inside with an insert hole. The permanent magnets are respectively shaped as an arcuate plate with a preset thickness to be respectively positioned between every two adjacent engage studs, restrictedly fixing the permanent magnets in position.

### BACKGROUND OF THE INVENTION

1. Field of the Invention

This invention relates to a ceiling fan D.C. motor, particularly to one able to be assembled quickly.

2. Description of the Prior Art

A conventional ceiling fan D.C. motor shown in FIG. 1 includes a stator 10 and a rotor 20. The stator 10 consists of a shaft 11 and an electro-magnetic member (not shown) fitted around the shaft 11 and wound thereon with coils (not shown). The rotor 20 to be mounted around the stator 10 is composed of an upper cover 21, a plurality of permanent magnets 27 and a lower cover 23. The permanent magnets 22 are arranged equidistantly and annularly to be secured on the inner circumferential wall of the upper cover 21. After being applied with glue, the permanent magnets 22 are fixedly positioned on the inner circumferential wall of the upper cover 21 by means of clamps, and after the glue is dried up, remove the clamps from the upper cover 21. The upper cover 21 has its circumferential edge punched from under with a plurality of bolt holes 211 spaced apart for a preset space and respectively aligned to the space between every two permanent magnets 22. The lower cover 23 has its circumferential edge punched from above with a plurality of threaded holes 231 respectively aligned to the bolt holes 211 of the upper cover 21, letting the other sides of the threaded holes 231 of the lower cover 23 respectively formed with a bulging portion 232. In assembling, firstly, the stator 10 has its shaft 11 positioned in the shaft hole 212 and 233 of the upper cover 21 and the lower cover 23. Next, a plurality of bolts 30 are respectively inserted through the bolt holes 211 of the upper cover 21 and then locked in the threaded holes 231 of the lower cover 23 to combine the stator 10 and the rotor 20 together.

However, in the structure of the conventional ceiling fan D.C. motor, the permanent magnets 22 must be first applied with glue and then fixed on the inner circumferential wall of the upper cover 21 by means of clamps and after the glue is dried up, the clamps are removed out from the upper cover 21, thus complicating assembly, and increasing time and lowering speeds in manufacturing. In addition, when the metallic locking members 30 with magnetism are respectively inserted in the space between two permanent magnets 22, the locking members 30 are likely to be interfered by the magnetism of the permanent magnets 22 and become difficult to be respectively aligned to the threaded holes 231 of the lower cover 23 and locked therein. Moreover, the lower cover 23 is formed with a comparatively thin wall; therefore, the bulging portion 232 of the threaded hole 231 punched from the topside of the lower cover 23 is comparatively weak in structure, increasing difficulty in assembling the bolts 30 with the threaded holes 231 of the lower cover 23.

### SUMMARY OF THE INVENTION

The objective of the invention is to offer a ceiling fan D.C. motor including a stator and a rotor fitted around the outer circumference of the stator. The rotor is composed of a holder, an annular base, a plurality of permanent magnets and a cover. The holder has its circumferential edge provided with an annular wall formed therein with an accommodating space and its upper side formed with an opening. The annular base is secured inside the circumferential wall of the holder and has its circumferential edge disposed with a plurality of engage studs spaced apart, extending longitudinally toward the opening of the holder and respectively bored with an insert hole in an upper surface. The permanent magnets respectively shaped as an arcuate plate with a preset thickness are respectively positioned between every two adjacent engage studs of the annular base. The cover is fixedly closed on the opening of the holder by means of plural locking members respectively inserted through the boltholes of the holder and the insert holes of the engage studs and then locked with the threaded holes of the cover. The permanent magnets respectively positioned between two engage studs of the annular base can be laterally and restrictedly positioned by the engage studs and firmly fixed inside the circumferential wall of the holder, quick in assembly of the D.C. motor.

### BRIEF DESCRIPTION OF DRAWINGS

This invention will be better understood by referring to the accompanying drawings, wherein:

FIG. 1 is an exploded perspective view of a conventional ceiling fan D.C. motor;

FIG. 2 is an exploded perspective view of a ceiling fan D.C. motor in the present invention;

FIG. 3 is a perspective view of a rotor in the present invention; and

FIG. 4 is a cross-sectional view of the ceiling fan D.C. motor in the present invention.

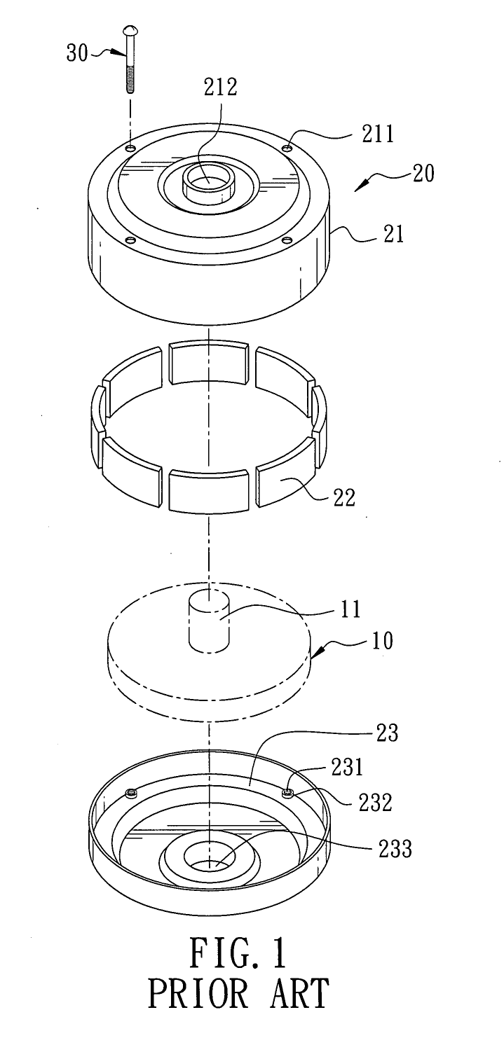

### DETAILED DESCRIPTION OF THE PREFERRED EMBODIMENT

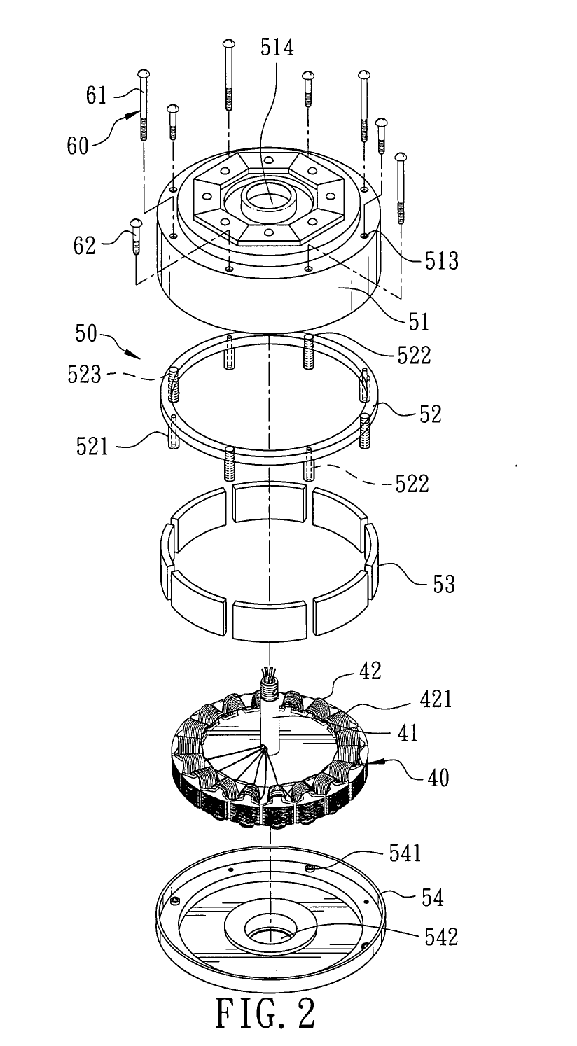

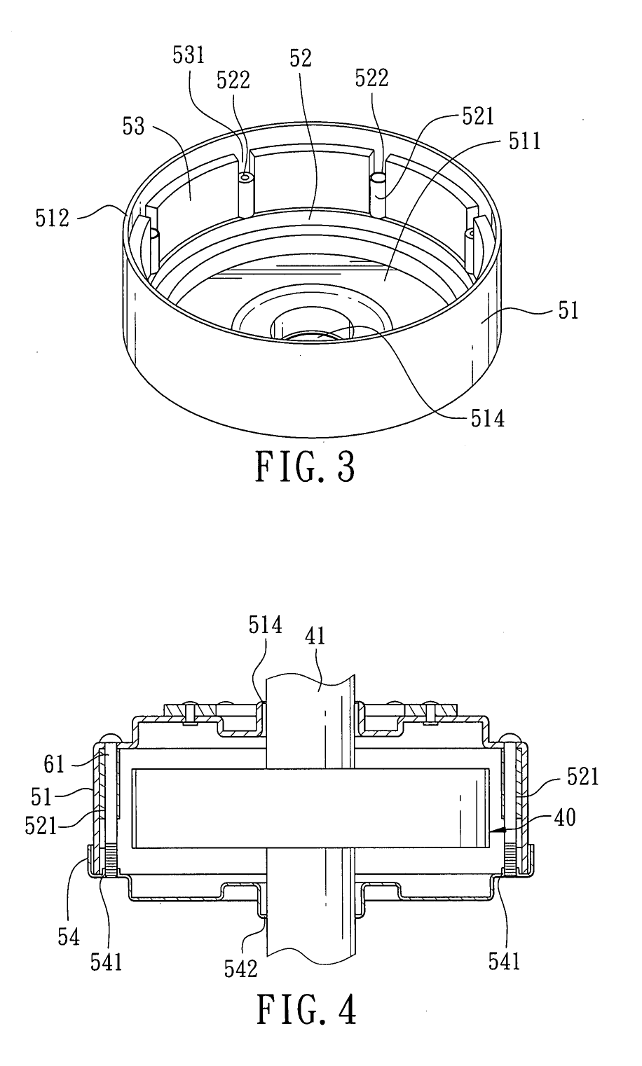

A preferred embodiment of a ceiling fan D.C. motor in the present invention, as shown in FIGS. 2, 3 and 4, includes a stator 40 and a rotor 50 as main components combined together.

The stator 40 consists of a shaft 41 and an electro-magnetic member 42, and the shaft 41 is inserted through the center of the electro-magnetic member 42, which is positioned around the shaft 41 and wound thereon with coils 421.

The rotor 50 is fitted around the outer circumference of the stator 40, composed of a holder 51, an annular base 52, a plurality of permanent magnets 53 and a cover 54.

The holder 51 has its circumferential edge provided with an annular wall extending upward and having an accommodating space formed in the interior. The holder 51 further has its upper side formed with an opening 512 and its lower circumferential edge punched from under with a plurality of bolt holes 513.

The annular base 52 made integral of plastic and fixed inside the circumferential wall of the holder 51 has its circumferential edge disposed with a plurality of cylindrical engage studs 521 spaced apart for a preset interval, extending longitudinally toward the opening 512 of the holder 51 and respectively bored with an insert hole 522 in an upper surface. Some engage studs 521 provided with the insert holes 522 formed with a female thread 523 and the other engage studs 522 provided with insert holes 522 without a female thread 523 are located alternately.

The permanent magnets 53 are respectively shaped as an arcuate plate with a preset thickness and formed with a width approximately equivalent to the interval between two engage studs 521 of the annular base 52. The permanent magnets 53 are annularly arranged and fixed on the inner circumferential wall of the holder 51 by gluing and respectively positioned between two adjacent engage studs 521. Thus, the cylindrical engage studs 521 respectively positioned in the conical space 531 formed between every two arc-shaped permanent magnets 53 can laterally and restrictedly position the permanent magnets 53 on the inner wall of the holder 51.

The cover 54 to be closed on the opening 512 of the holder 51 has its outer circumferential edge punched from above with a plurality of threaded holes 541 respectively aligned to the bolt holes 513 of the holder 51. The cover 54 is firmly mounted on the opening 512 of the holder 51 by locking members 60 (bolts) respectively inserted through the bolt holes 513 of the holder 51 and the insert holes 522 of the engage studs 521 of the annular base 52 and then locked with the threaded holes 541 of the cover 54.

In assembling, firstly, the center shaft 41 of the stator has its opposite ends respectively inserted through and fixed in the shaft hole 514 and 542 of the holder 51 and the cover 54. Next, a plurality of short bolts 62 are respectively inserted through the bolt holes 513 from the bottom of the holder 51 and locked with the engage studs 521 that are respectively formed with the female threads 523, fixing the annular base 52 in the holder 51. Subsequently, plural long bolts 61 are respectively inserted through the other bolt holes 513 from under the holder 51 and through the insert holes 522 of the other engage studs 521 that are provided with no female threads 523, and then the long bolts 61 have their ends respectively locked in the threaded holes 541 of the cover 54, thus finishing assembly of the D.C. motor.

To sum up, this invention has the following advantages.

1. The annular base is disposed with a plurality of cylindrical engage studs extending longitudinally for laterally and restrictedly fixing the arc-shaped permanent magnets respectively between every two adjacent engage studs, able to quickly fix the permanent magnets in position.

2. The annular base can be firmly secured in the interior of the holder by means of the locking members respectively inserted through the bolt holes of the holder and locked with the engage studs that are formed with the female threads.

3. The engage studs enable the locking members to be respectively and quickly locked with the threaded holes of the cover through the insert holes of the engage studs, combining the holder and the cover together quickly and precisely.

While the preferred embodiment of the invention has been described above, it will be recognized and understood that various modifications may be made therein and the appended claims are intended to cover all such modifications that may fall within the spirit and scope of the invention.

What is claimed is:

1. A ceiling fan D.C. motor comprising:
a stator composed of a center shaft and an electro-magnetic member, said electro-magnetic member fitted around said shaft and wound thereon with coils; and
a rotor fitted around an outer circumferential side of said stator, said rotor comprising:
a holder having its circumferential edge provided with an annular wall extending upward, said holder formed with an accommodating space in the interior and an opening in an upper side;
an annular base fixed inside the circumferential wall of said holder, said annular base having its circumferential edge disposed with a plurality of engage studs spaced apart for a preset interval and extending longitudinally toward said opening of said holder, said engage studs respectively bored with an insert hole in an upper surface;
a plurality of permanent magnets respectively shaped as an arcuate plate with a preset thickness, the width of each said permanent magnet approximately equivalent to the interval between two adjacent said engage studs, each said permanent magnet positioned between two adjacent said engage studs, said permanent magnets able to be restrictedly positioned inside the circumferential wall of said holder by said engage studs of said annular base; and
a cover closed on said opening of said holder, said cover firmly mounted on said holder by means of plural locking members respectively inserted through said insert holes of said engage studs and locked on said holder.

2. The ceiling fan D.C. motor as claimed in claim 1, wherein said engage studs are respectively shaped as a cylinder, and between every two said arcuate permanent magnets is formed a conical space, said engage studs respectively positioned in said conical space to laterally restrictedly fix said permanent magnets in position.

3. The ceiling fan D.C. motor as claimed in claim 1, wherein said permanent magnets are secured on the inner circumferential wall of said holder by gluing.

4. The ceiling fan D.C. motor as claimed in claim 1, wherein said annular holder is formed integral of plastic.

5. The ceiling fan D.C. motor as claimed in claim 1, wherein said locking members are bolts.

6. The ceiling fan D.C. motor as claimed in claim 1, wherein parts of said engage studs of said annular base are respectively formed with female threads so that said annular base is fixed in said holder by means of said locking members.
